(19) United States
(12) Patent Application Publication
(10) Pub. No.: US 2023/0239283 A1
(43) Pub. Date: Jul. 27, 2023

(54) DESTINATION-BASED POLICY SELECTION AND AUTHENTICATION

(71) Applicant: ThreatSTOP, Inc., Carlsbad, CA (US)

(72) Inventor: John Bambenek, Carlsbad, CA (US)

(21) Appl. No.: 17/996,407

(22) PCT Filed: Dec. 17, 2020
(86) PCT No.: PCT/US2020/065767

§ 371 Date: Oct. 17, 2022

Related U.S. Application Data
(60) Provisional application No. 62/949,399, filed on Dec. 17, 2019.

(51) Int. Cl. H04L 9/40

(52) U.S. Cl. CPC H04L 63/0807; H04L 63/20; H04L 63/1483; H04L 63/0236; H04L 63/108

(57) ABSTRACT

Techniques for allowing client devices to securely request services from remote servers without using a reproducible token on the client are disclosed. In an embodiment, the host-portion of a destination address, in whole or in part, is used as an authentication token to identify an end-user, to be a selector to retrieve a security or other policy, or to provide device-specific or user-specific content. In an embodiment, repeated unauthorized attempts to access services are monitored to allow a human or artificial network agent to take appropriate defensive action against attacks.

### CROSS REFERENCE TO RELATED APPLICATIONS

This application is a national phase application pursuant to 35 U.S.C. § 371 of International Application No. PCT/US2020/065767 filed on Dec. 17, 2020, which claims priority to U.S. Provisional Application No. 62/949,399 filed on Dec. 17, 2019, the disclosures of which are hereby incorporated by reference herein.

### BACKGROUND

All network communication on the Internet using the Internet Protocol (IP) requires a source and destination IP address. In IP version 4 (IPv4), there is a total of a little more than 4 billion global internet addresses, codified by a 32-bit binary string. With the growth of the Internet, this number has proved insufficient as there are over 7 billion people as of this writing. Additionally, the growth in mobile devices and IoT devices, each requiring addressing, has further exacerbated the address exhaustion problem.

Technologists have responded to this problem with the creation of IP version 6 (IPv6) which uses 128-bit binary strings typically divided into a 64-bit portion for the network and 64-bit for the specific host portion on that network. That allows for 340 undecillion globally unique and publicly routable addresses, a preposterously large amount. For reference, if one evenly allocated just the unique network portion, e.g., the first 64 bits, evenly to every person on the planet, each individual would have over 2 billion networks for their own personal usage, with each network having an addressing capacity of 18.4 quintillion unique addresses each.

The growth in the Internet has posed challenges that have remained despite the advances of technology. One of those challenges is how to enable secure transactions over an untrusted global network that can be manipulated or monitored. The current solution of using passwords (or some form thereof) has been the typical method to address this problem. This comes with its own vulnerabilities in that the password can be stolen, it is reused with another service where it is stolen, or the password is cryptographically easy to guess. Additionally, even in systems that rely on various forms of multi-factor authentication rely on storing something (such as a cookie) on the client machine which can then be stolen and reused to impersonate a user.

### SUMMARY

A token generator creates a cryptographically secure token comprised of several different components, including a source address of the device to make impersonation attacks implausible, to make predictability of the destination address infeasible. A token-retrieval engine of the client device has knowledge of which precise destination address it should use. A network address update engine updates a given or arbitrary application with a correct network address, so the client requests the correct address and the service as aware of the correct authentication or policy mapping based on the source address. An optional security monitor looks for failed authentication requests such that they can be programmatically blocked for repeated invalid attempts.

The host-portion of a destination address, in whole or in part, can be used to identify an end-user. For instance, for a destination address of 2600:0ab2:31a5:28ba:93bc:ec00:1b7c:8420, the network portion would be “2600:0ab2:31a5:28ba” and the host portion would be “93bc:ec00:1b7c:8420”. An Internet-facing service listening on all possible address combinations underneath the network portion can use as an authentication token “93bc:ec00:1b7c:8420,” in whole or in part, to identify the end-user, to be a selector to retrieve a security or other policy, or to provide device-specific or user-specific content.

This methodology allows for client devices to securely request services from remote servers without using a reproducible token on the client that could be compromised. It can be used in Internet-of-Things (IoT) devices and mobile devices to, for instance, have specific responses or security policy be imposed without modification of the device itself. Other features and advantages of the present invention should be apparent from the following description which illustrates, by way of example, aspects of the invention.

### BRIEF DESCRIPTION OF THE DRAWINGS

FIG. 1 is a diagram of an example of a system for destination-based policy selection and authentication.

FIG. 2 is an illustration of an example IPv6 address and how a portion can be used as a unique identifier for a specific Internet service and how the remaining portion can be used for an authentication token.

FIG. 3 is a logical diagram of phases for using an IPv6 destination address as an authentication token and providing individualized responses or policy.

FIG. 4 is a logical diagram of phases for new IPv6 destination address authentication.

FIG. 5 is a logical diagram of phases for new IPv6 destination address revocation through logout.

FIG. 6 is a diagram of an example of an authentication server.

FIG. 7 is a flowchart of an example of a method of authentication.

FIG. 8 is a flowchart of an example of a method for providing resources in accordance with destination-based policy selection and authentication.

### DETAILED DESCRIPTION

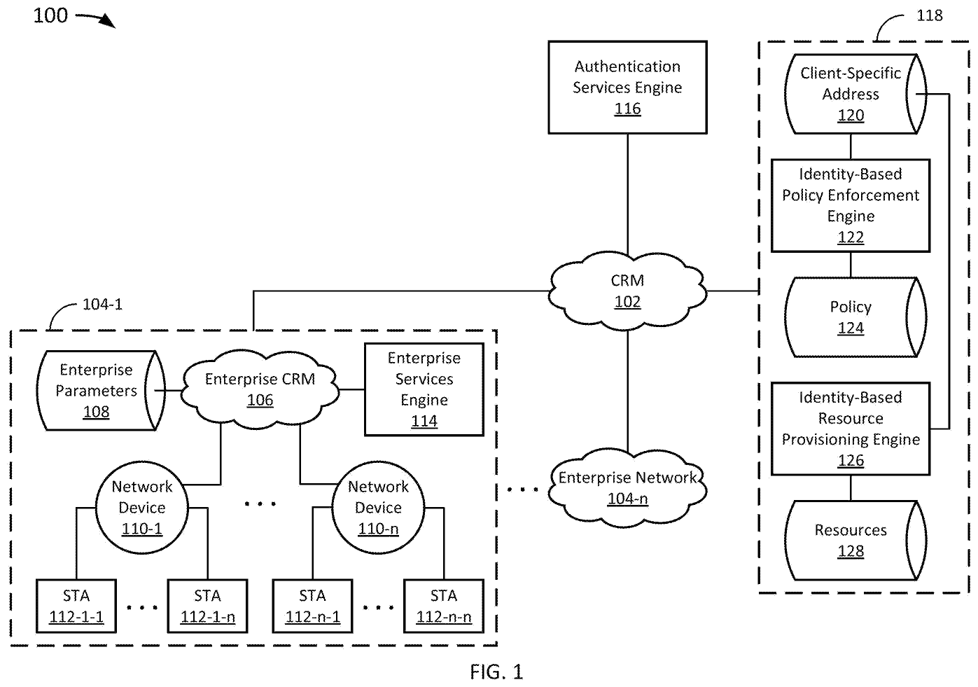

FIG. 1 is a diagram 100 of an example of a system for destination-based policy selection and authentication. The diagram 100 includes a computer-readable medium (CRM) 102, an enterprise network system 104-1 to an enterprise network system 104-n (collectively, enterprise networks 104) coupled to the CRM 102, an authentication services engine 116 coupled to the CRM 102, and an identity-based policy enforcement and service provisioning system 118 coupled to the CRM 102. The enterprise networks 104 include an enterprise CRM 106, an enterprise parameters datastore 108 coupled to the enterprise CRM 106, a network device 110-1 to a network device 110-n (collectively, network devices 110) coupled to the enterprise CRM 106, a station 112-1-1 to a station 112-1-n (collectively, the stations 112-1) coupled to the network device 110-1 to a station 112-n-1 to a station 112-n-n (collectively, the stations 112-n) coupled to the network device 110-n, and an enterprise services engine 114 coupled to the enterprise CRM 106. (The stations 112-1 to 112-n can collectively be referred to as the stations 112.) The identity-based policy enforcement and service provisioning system 118 includes a client-specific address datastore 120, an identity-based policy enforcement engine 122 coupled to the client-specific address datastore 120, a policy datastore 124 coupled to the identity-based policy enforcement engine 122, an identity-based resource provisioning engine 126 coupled to the client-specific address datastore 120, and a resources datastore 128 coupled to the identity-based resource provisioning engine 126. Interfaces for communicating across networks and CRMs are omitted from the figure to avoid clutter but are assumed where applicable to facilitate a coupling of components.

The CRM 102 may comprise a computer system or network of computer systems. A “computer system,” as used herein, may include or be implemented as a specific purpose computer system for carrying out the functionalities described in this paper. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

Memory of a computer system includes, by way of example but not limitation, random access memory (RAM), such as dynamic RAM (DRAM) and static RAM (SRAM). The memory can be local, remote, or distributed. Non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. During execution of software, some of this data is often written, by a direct memory access process, into memory by way of a bus coupled to non-volatile storage. Non-volatile storage can be local, remote, or distributed, but is optional because systems can be created with all applicable data available in memory.

Software in a computer system is typically stored in non-volatile storage. Indeed, for large programs, it may not even be possible to store the entire program in memory. For software to run, if necessary, it is moved to a computer-readable location appropriate for processing, and for illustrative purposes in this paper, that location is referred to as memory. Even when software is moved to memory for execution, a processor will typically make use of hardware registers to store values associated with the software, and a local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus of a computer system can couple a processor to an interface. Interfaces facilitate the coupling of devices and computer systems. Interfaces can be for input and/or output (I/O) devices, modems, or networks. I/O devices can include, by way of example but not limitation, a keyboard, a mouse or other pointing device, disk drives, printers, a scanner, and other I/O devices, including a display device. Display devices can include, by way of example but not limitation, a cathode ray tube (CRT), liquid crystal display (LCD), or some other applicable known or convenient display device. Modems can include, by way of example but not limitation, an analog modem, an IDSN modem, a cable modem, and other modems. Network interfaces can include, by way of example but not limitation, a token ring interface, a satellite transmission interface (e.g. “direct PC”), or other network interface for coupling a first computer system to a second computer system. An interface can be considered part of a device or computer system.

Computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor or a portion thereof; 2) hardware, firmware, and/or software modules executed by the processor. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Assuming a CRM includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (HTTP) for hypertext markup language (HTML) documents that make up the World Wide Web (“the web”). More generally, a network can include, for example, a wide area network (WAN), metropolitan area network (MAN), campus area network (CAN), or local area network (LAN), but the network could at least theoretically be of an applicable size or characterized in some other fashion (e.g., personal area network (PAN) or home area network (HAN), to name a couple of alternatives). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

Referring once again to the example of FIG. 1, the enterprise networks 104 are intended to represent a network under the control of a private (often corporate) entity. The enterprise networks 104 can be implemented as LANs coupled together to form an extended private network. The enterprise networks 104 are also intended to include public switched telephone networks (PSTNs), mobile networks, and other communication networks. It may be noted certain terminology that is used to describe components of the enterprise networks 104 may be different that would typically be used for certain networks. For example, an 802.11-compliant network may be described as having access point stations and non-access point stations, while a mobile network may be described as having base stations and mobile transceivers.

The enterprise CRM 106 is intended to represent a CRM that is under the control of the private entity that controls the applicable enterprise network, or under the control of an entity that is connected to the enterprise CRM 106, such as a person with a mobile device that is connected to the enterprise CRM 106.

The enterprise parameters datastore 108 is intended to represent a datastore of network parameters, known device parameters, account parameters, and the like. Enterprise parameters are not necessarily shared with parties outside of the applicable one of the enterprise networks 104. Advantageously, the enterprise parameters need not be shared with other entities for the authentication purposes described later, though information is still passed outside of the enterprise networks 104 in, e.g., IP packets, when packets are transmitted outside of the enterprise networks 104.

The network devices 110 are intended to represent routers, switches, access points, gateways, including wireless gateways, repeaters, or any combinations thereof. In functioning as gateways, network devices can transport data from a backend of a network to a device coupled to the network devices. In functioning as access points, network devices can couple a device coupled to the network devices to a network associated with the network devices. In a specific implementation, at least one of the network devices 110 is a wireless access point (WAP). In an 802.11-compliant implementation, a WAP is a networking hardware device that allows a wireless device to connect to a backbone network in compliance with the IEEE 802.11 standard. IEEE 802.11a-1999, IEEE 802.11b-1999, IEEE 802.11g-2003, IEEE 802.11-2007, and IEEE 802.11n TGn Draft 8.0 (2009) are incorporated by reference. In alternative embodiments, one or more of the network devices 110 may comply with a different standard other than IEEE 802.11, such as Bluetooth and ZigBee.

IEEE 802.3 is a working group and a collection of IEEE standards produced by the working group defining the physical layer and data link layer's MAC of wired Ethernet. This is generally a local area network technology with some wide area network applications. Physical connections are typically made between nodes and/or infrastructure devices (hubs, switches, routers) by various types of copper or fiber cable. IEEE 802.3 is a technology that supports the IEEE 802.1 network architecture. As is well-known in the relevant art, IEEE 802.11 is a working group and collection of standards for implementing wireless local area network (WLAN) computer communication in the 2.4, 3.6 and 5 GHz frequency bands. The base version of the standard IEEE 802.11-2007 has had subsequent amendments. These standards provide the basis for wireless network products using the Wi-Fi brand. IEEE 802.1 and 802.3 are incorporated by reference. Wi-Fi is a non-technical description that is generally correlated with the IEEE 802.11 standards, as well as Wi-Fi Protected Access (WPA) and WPA2 security standards, and the Extensible Authentication Protocol (EAP) standard.

The stations 112 are intended to represent wireless devices. In a specific implementation, a wireless device is a thin client device or an ultra-thin client device that includes a wireless network interface, through which the wireless device can receive data wirelessly through a wireless communication channel. The wireless network interface can be used to send data generated by the wireless device to remote or local systems, servers, engines, or datastores through a wireless communication channel. In a specific example, the wireless communication channel is a cellular communication channel. In an 802.11-compatible or 802.11-compliant implementation, a wireless device is 802.11 standards-compatible or 802.11 standards-compliant. As used in this paper, a system or device that is 802.11 standards-compatible or 802.11 standards-compliant complies with at least some of one or more of the incorporated documents' requirements and/or recommendations, or requirements and/or recommendations from earlier drafts of the documents and includes Wi-Fi systems. The stations 112 can be referred to as “on” a wireless network of an enterprise network but may or may not be the property of the enterprise. For example, the stations 112 could include privately owned devices that access services through a guest or other network of an enterprise network, or IoT devices owned by the enterprise that are on a wireless network of the enterprise. In the example of FIG. 1, the network devices 110 are depicted with the stations 112 but it should be understood not all network devices have stations.

The enterprise services engine 114 is intended to represent an engine that provides network and other services to the stations 112. Network services can include services provided by a server within an applicable one of the network enterprises 104 or services that enable access to servers outside of the applicable one of the network enterprises 104. The latter includes authentication services as described next.

The authentication services engine 116 is intended to represent an engine that provides an authentication service in association with a client-server session between one of the stations 112 (for illustrative purposes, the station 112-1-1, referred to hereinafter with reference to FIG. 1 as a “first station,” of the enterprise network 104-1, referred to hereinafter with reference to FIG. 1 as a “first enterprise network”) and the identity-based policy enforcement and service provisioning system 118. In a specific implementation, the authentication services engine 116 includes multiple authoritative name servers for multiple domains. In an implementation that utilizes a hierarchical and decentralized naming system for computers, services, and other resources connected to the Internet or a private network, such as the Domain Name Service (DNS), the authentication services engine 116 associates various information with domain names assigned to participating entities. The DNS also translates more readily memorized domain names to numerical IP addresses needed for locating and identifying computer services and devices with the underlying network protocols.

Network administrators may delegate authority over sub-domains in their allocated name space to other servers, which may be considered part of the authentication services engine 116 or the identity-based policy enforcement and service provisioning system 118, depending upon implementation-, configuration-, or preference-specific factors (or context). For example, a subdomain can be delegated to a manager as a zone of administrative autonomy that can be considered part of the authentication service engine 116 when operated by a registry or as part of the identity-based policy enforcement and service provisioning system 118 when operated by an agent of the identity-based policy enforcement and service provisioning system 118.

The identity-based policy enforcement and service provisioning system 118 is intended to represent an engine that provides cloud services, content from a content delivery network, or other resources with policy enforcement that depends upon what client is requesting the applicable resources. In a specific implementation, when granting access to a distributed Internet service using a URL, the domain name of the URL is translated to the IP address of a server that is proximal to the client. Advantageously, first and second clients can simultaneously receive different translations for the same domain name in accordance with respective first and second policies.

The client-specific address datastore 120 is intended to represent a datastore of a domain name. The domain name can be translated into an IP address by a resolver, such as a DNS resolver. However, multiple domain names may be associated with a single IP address. Accordingly, in a specific implementation, they are stored in the form of specially formatted names in pointer (PTR) records with an infrastructure top-level domain arpa. For example, in-addr.arpa for IPv4 and ip6.arpa for IPv6. In this implementation, the client-specific address datastore 120 can include data sufficient to enable a lookup or a reverse lookup.

The identity-based policy enforcement engine 122 is intended to represent an engine that enforces policy depending upon an entry associated with a first client in the client-specific address datastore 120. Advantageously, because a first address domain name is specific to the first client, resources of the domain name can be provided in a manner that is specific to a customized policy for the first client. In a specific implementation, all clients are individually identifiable from the client-specific address datastore 120, so each client has an associated policy in the policy datastore 124 and can only access resources in accordance with that policy.

The policy datastore 124 is intended to represent a datastore of policy parameters, with at least a first set of parameters applicable to a first client and a second set of parameters, different from the first set of parameters, applicable to a second client when the first client and the second client access a first domain.

The identity-based resource provisioning engine 126 is intended to represent an engine that provides access to resources for clients in accordance with policy enforced by the identity-based policy enforcement engine 122. In a specific implementation, both the policy and the appropriate resource provisioning are determinable from the client-specific address datastore 120. In an implementation in which IPv6 is used, both identification of an appropriate policy and available resources are determinable from an IPv6 destination address of a client.

The resources datastore 128 is intended to represent a datastore of resources that can be provided to clients in accordance with client-specific policy and resource requests. For example, the resources datastore 128 can include content or parameters associated with non-content resource requests.

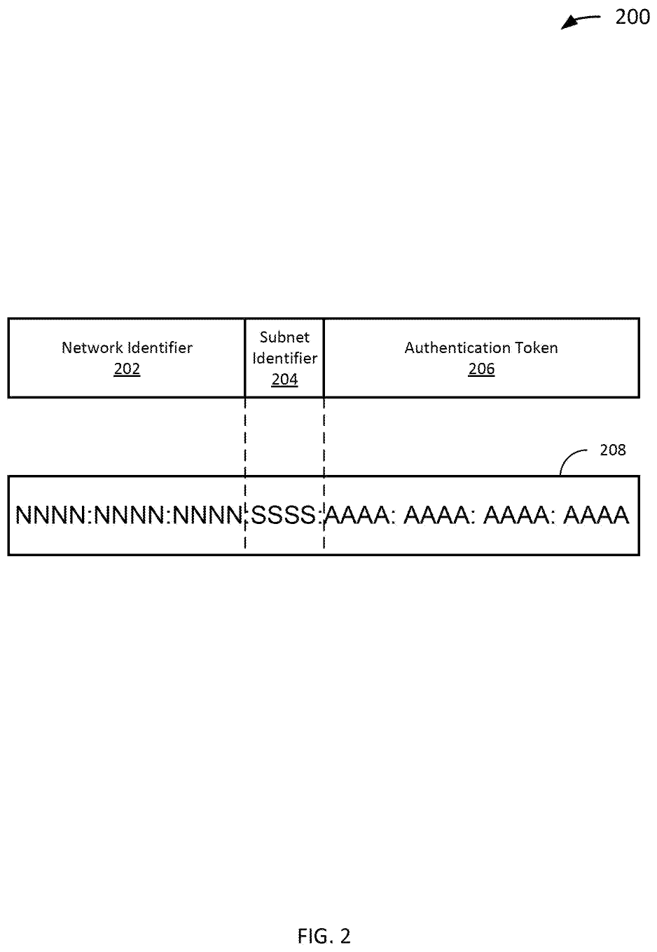

FIG. 2 is block diagram 200 of an example IPv6 address and how a portion can be used as a unique identifier for a specific Internet service and how the remaining portion can be used for an authentication token. An IPv6 address is used in this example because of its ubiquity and likely applicability far into the future. Nevertheless, IPv6 is intended to represent an example and similar techniques to those described here could be used with IPv4, a proprietary technology, or a future technology. The diagram 200 includes a network identifier 202, a subnet identifier, and an authentication token. The diagram 200 also includes an IPv6 address representation 208.

The network identifier 202 is intended to represent the first 12 hexadecimal digits of an IPv6 address. In the IPv6 address representation 208, these 12 hexadecimal digits are represented as “NNNN:NNNN:NNNN,” the N's intending to represent “network” as in “network identifier.” The address space should be sufficient to represent all networks currently and for a very long time into the future.

The subnet identifier 204 is intended to represent the fourth group of four hexadecimal digits of an IPv6 address. In the IPv6 address representation 208, these 4 hexadecimal digits are represented as “SSSS,” the S's intending to represent “subnet” as in “subnet identifier.” However, the subnet identifier 204 could instead or in addition identify a specific server.

The authentication token 206 is intended to represent the last 16 hexadecimal digits of an IPv6 address. In the IPv6 address representation 208, these 16 hexadecimal digits are represented as “AAAA:AAAA:AAAA:AAAA,” the A's intending to represent “authentication” as in “authentication token.” The authentication token 206 in this example is exceptionally large. In an alternative, only a subset of the indicated number of hexadecimal digits are used as an authentication token, with the remainder being used for other purposes or kept in reserve. For illustrative purposes, however, the indicated authentication token is suitable.

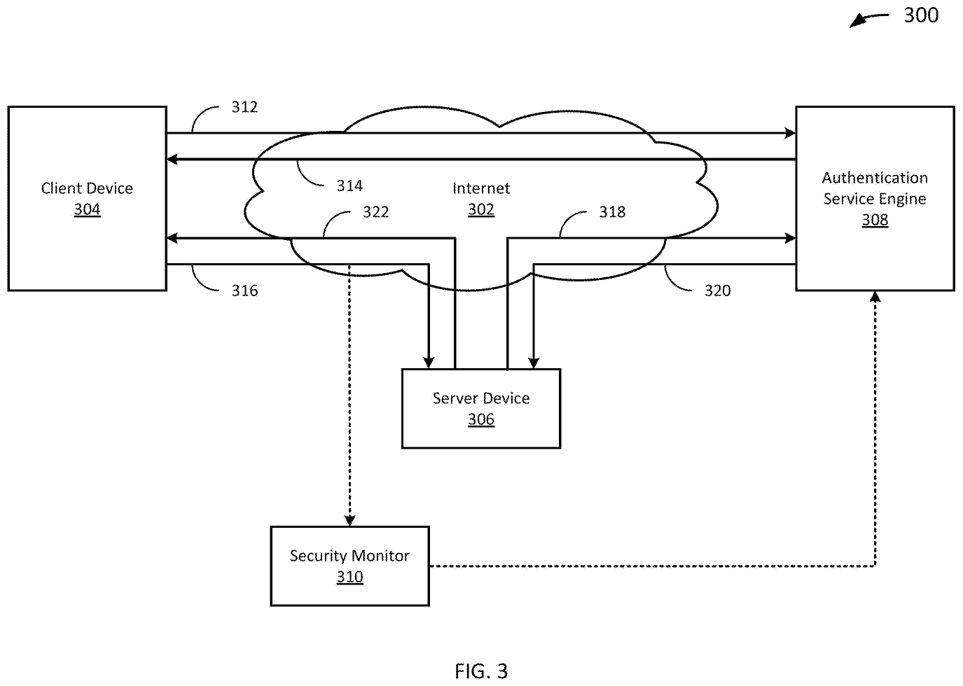

FIG. 3 is a logical diagram 300 of phases for using an IPv6 destination address as an authentication token and providing individualized responses or policy. The diagram 300 is intended to illustrate a methodology of generating an IPv6 address with authentication token, using that address to obtain individualized service, and to manage the lifecycle of that address in a reasonably secure manner. The diagram 300 includes the Internet 302, a client device 304, a server device 306, and an authentication service device 308. The diagram 300 also includes an optional security monitor 310. The authentication service engine 308 is depicted as being coupled to the server device 306 via the Internet 302 but in an alternative the authentication service engine 308 is a function implemented within the server device 306, is part of the service provided by the server device 306, is a separate service on the server device 306, or is otherwise implemented on a device other than the server device 306 and coupled to the server device 306 via a CRM that is not the Internet 302. The security monitor 310 is also depicts as coupled to the server device 306 and the authentication service engine 308 via the Internet 302 but in an alternative could be coupled to the server device 306 and/or the authentication service engine 308 via a CRM that is not the Internet 302.

For the purposes of this example, the client device 304 wants a service that the server device 306 provides over the Internet 302, with the authentication service engine 308 accepting information from the client device 304 to generate a destination address with an authentication token. It is assumed, for illustrative purposes, the client device 304 has something to query in association with a client application (or an application that makes a request on behalf of the client application, the specifics of which are unnecessary for an understanding of this methodology).

In transaction 312, the client device 304 sends an authentication request over the Internet 302 to the authentication service engine 308. The authentication request includes identifying information. The authentication request may or may not include a unique client identifier or use a username and password with the potential inclusion of various forms of multi-factor authentication for secure applications. In whatever form it takes, some information is provided in the authentication request that the authentication server 308 can use to uniquely identify the client device 304. In a specific implementation, the server device 306 notifies the client device 304 when authentication or reauthentication is required (not shown) so transaction 312 (and transaction 314, described next) occur programmatically and transparently to an end user of the client device 304.

By way of example, a webserver (included in the server device 306) provides individualized responses for authenticated users. This webserver listens on the network 2600:abcd:1234:0001:[all address on this subnet]. As part of transaction 312, “Alice” (end-user of the client device 304) queries an authentication service (included in the authentication service engine 308). As part of another transaction 312, “Bob” (end-user of a client device that is not illustrated) also queries the authentication service.

In transaction 314, the authentication service engine 308 returns a destination address with an authentication token to the client device 304 over the Internet 302. The authentication service engine 308 generates an authentication token that will comprise no more than 64 bits of the host portion of an IPv6 destination address. In a specific implementation, the authentication token is generated in a deterministic but pseudo-random way using information provided by the client device 304 and a source network of the client device 304 to prevent the same destination address being used by a malicious third party who snoops the traffic to determine destination addresses.

Continuing the example with Alice and Bob, Alice obtains an authentication token of 0000:0000:0000:0001. In a specific implementation, the authentication server incorporates the authentication token into a network domain destination 2600:abcd:1234:0001, returning to Alice the IPv6 destination address 2600:abcd:1234:0001:0000:0000:0000:0001. Bob also requests service from the authentication server and receives a token of 0000:0000:0000:0002. In a specific implementation, the authentication server sends Bob the IPv6 destination address 2600:abcd:1234:0001:0000:0000:0000:0002.

In a specific implementation, for servers that may occupy multiple networks, or to accommodate users who are moving globally and wanting to reach a physical server nearest to them, the authentication token is independent of which specific network portion is used in the IPv6 address. For example, continuing the example of Alice and Bob, in addition to the network 2600:abcd:1234:0001, assume a service uses three additional networks associated within the same authentication domain:2600:abcd:1234:0002, 2600:abcd:1234:0003, and 2600:abcd:1234:0004. Depending upon implementation-specific, configuration-specific, or other factors or preferences, Alice's authentication token 0000:0000:0000:0001 and Bob's authentication token 0000:0000:0000:0002 can be used with all four networks (or some other number of networks that may be in use by a specific service provider).

In transaction 316, the client device 304 uses the destination address provided by the authentication service engine 308 to request service from the server device 306 over the Internet 302. The security monitor 310 listens to the transaction 316 for the purpose of detecting when there are repeated unauthorized attempts to access a system. (In this example, the attempts to authorize the system are presumed to be authorized.) In a specific implementation, the security monitor 310 monitors repeated unauthorized attempts to access service with particular attention on communication that uses an otherwise valid destination address from a new source network or with a token that has already been expired; this would allow a human or artificial network agent to take appropriate defensive action against attacks. Instead or in addition, the security monitor 310 could listen to other transactions for the purpose of detecting when there are repeated unauthorized attempts.

Due to the size of a 64-bit number, the ability to brute force a valid destination address is greatly constrained, especially in the presence of the security monitor 310. It is mathematically feasible to guess a valid destination address offline. In practice, however, the attack would have to query repeatedly until a successful request took place; that attack would become obvious to the security monitor 310 and easy to defend against once detected.

Continuing the example with Alice and Bob, Alice's web browser requests web content from the IPv6 address of 2600:abcd:1234:0001:0000:0000:0000:0001. Bob's web browser requests web content from the IPv6 address of 2600:abcd:1234:0001:0000:0000:0000:0002. Assuming the service uses the three additional networks associated within the same authentication domain, as mentioned previously, Alice's browser could have also requested the IPv6 address of 2600:abcd:1234:0002:0000:0000:0000:0001, 2600:abcd:1234:0003:0000:0000:0000:0001, or 2600:abcd:1234:0004:0000:0000:0000:0001. Bob's web browser could have done the same using Bob's authentication token 0000:0000:0000:0002.

In transaction 318, the server device 306 verifies information with the authentication service engine 308 over the Internet 302. The server device 306 receives network communication on the destination address, extracts out the authentication token, and communicates with the authentication service to determine the validity of the token and the identity of the entity the token represents.

Continuing the example with Alice and Bob, the webserver, listening on all addresses in the network, sees the full address provided by Alice and parses out the authentication token 0000:0000:0000:0001 to determine it is the authentication token corresponding to Alice. The webserver similarly determines the authentication token 0000:0000:0000:0002 corresponds to Bob.

In transaction 320, the authentication service engine 308 provides unique identity and validity information in association with the client device 304 to the server device 306 over the Internet 302.

Continuing the example with Alice and Bob, the web server validates that the authentication token 0000:0000:0000:0001 of the IPv6 destination address 2600:abcd:1234:0001:0000:0000:0000:0001 belongs to Alice, and validates that the authentication token 0000:0000:0000:0002 of the IPv6 destination address 2600:abcd:1234:0001:0000:0000:0000:0002 belongs to Bob.

In transaction 322, the server device 306 fulfills the request from the client device 304 providing customized and individualized information to the client device 304 and enforcing policy appropriate for the client device 304 that the server device 306 is configured to enforce. Continuing the example of Alice and Bob, the webserver responds with individualized web content appropriate for Alice and individualized web content appropriate for Bob. The content (and policy) appropriate for Alice may be different from the content (and policy) appropriate for Bob.

With individualized security policy, DNS servers can modify the response to DNS requests based on security policy to, for instance, block all attempts to resolve a malicious domain name. DNS resolution is the means by which humans can enter memorable address (like www.uspto.gov) into a computer where it can be converted into machine-readable addresses (e.g. IPv6) so network traffic can be sent across the Internet. For DNS server providers, it is currently a challenge to provide custom DNS resolution policies by client because there is no authentication in the protocol aside from using source IP address, which is not sufficient to identify an end user, for instance, in a mobile network.

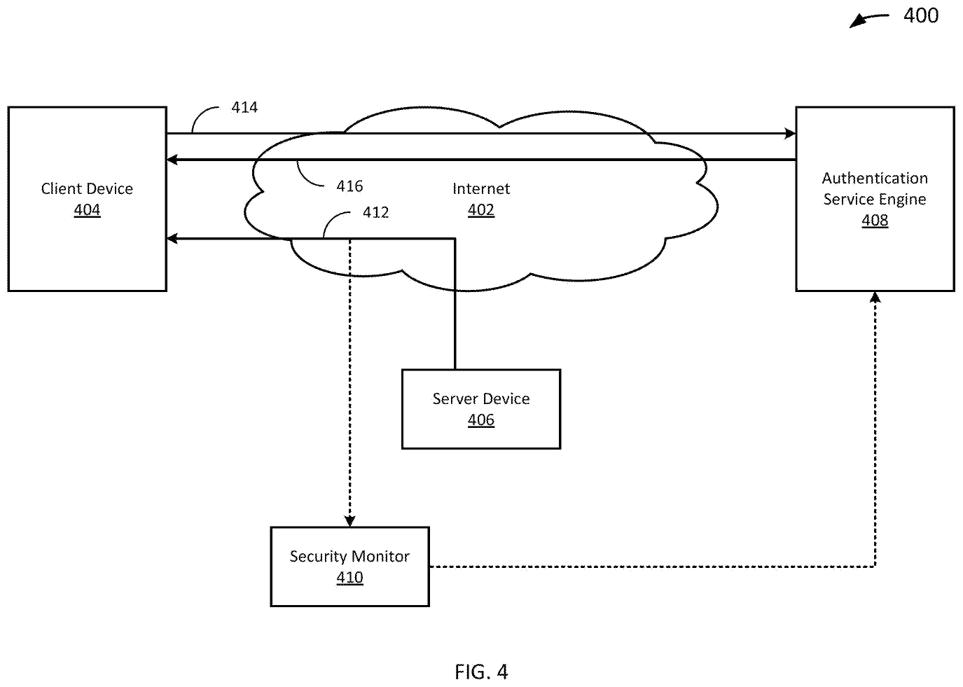

Continuing the example of Alice and Bob, let us assume Alice's client device is a mobile device. In this modified example, Alice's mobile device (equivalent to the client device 304 for the purposes of this illustrative example) would query an authentication server (equivalent to the authentication service engine 308) for a destination address (equivalent to the transaction 312), which the authentication server provides (equivalent to the transaction 314). Alice's mobile device would then forward DNS resolution requests to that destination address (equivalent to the transaction 316), which a web server (equivalent to the server device 306) verifies (equivalent to the transactions 318, 320) before fulfilling the request (equivalent to the transaction 322). Advantageously, in this example, the web server can enforce a customized DNS resolution policy based on the identity of the person using the mobile device, which is Alice in this case. As the mobile device changes its source IP address, it reauthenticates with the authentication server (disabling the previous authentication token) to get a new destination address, which is described with reference to FIG. 4, below. Advantageously, this would allow a measure of security policy to be enforced on a mobile device without significant changes to the device while it moves throughout the world, inside and outside of many networks as it does so.

FIG. 4 is a logical diagram 400 of phases for new IPv6 destination address authentication. The diagram 400 includes the Internet 402, a client device 404, a server device 406, an authentication service device 408, and a security monitor 410. The components 402-410 can be implemented in a manner like that described with reference to the components 302-310 of FIG. 3.

For the purposes of this example, an optional service includes additional security to expire authentication tokens. In a specific implementation, for security purposes, sessions expire after an arbitrary, algorithmically determined, periodic, or other span of time. It is assumed, for illustrative purposes, the server device 406 fulfilled a request from the client device 404 like the server device 306 of FIG. 3 fulfilled a request from the client device 304 of FIG. 3, as described previously, such that the client device 404 initially has an “old” or “previously active” IPv6 destination address, which has expired at the outset of this example.

In transaction 412, the server device 406 notifies the client device 404 that a previously active IPv6 destination address has expired. In a specific implementation, the notification is prompted server-side with a message of the transaction 412 indicating the authentication token is expired and a new token needs to be generated. This optional technique can be used to ensure the authentication token is expired after a time span to force re-authentication. In a specific implementation, the security monitor 410 is made aware of the expiration of the authentication token at the server device 406 and informs the authentication service engine 408 of the expiration.

In transaction 414, the client device 404 makes a request for reauthentication across the Internet 402 to the authentication service engine 408. In an alternative, the transaction 414 precedes or replaces the transaction 412. Specifically, if reauthentication is initiated on the client side instead of server side, the transaction 412 may be obviated. In this alternative, the security monitor 410 is made aware of the expiration of the authentication token at the client device 404 and informs the authentication service engine 408 of the expiration. (Note: The security monitor 410 is not shown listening to the transaction 414 in FIG. 3.)

In transaction 416, responsive to the request for reauthentication, the client device 404 receives from the authentication service engine 408 across the Internet 402 a new authentication token with which to formulate a new destination address. The client device 404 and the server device 406 can work together like the client device 304 and the server device 306 are described working together with reference to transactions 316-322 in FIG. 3.

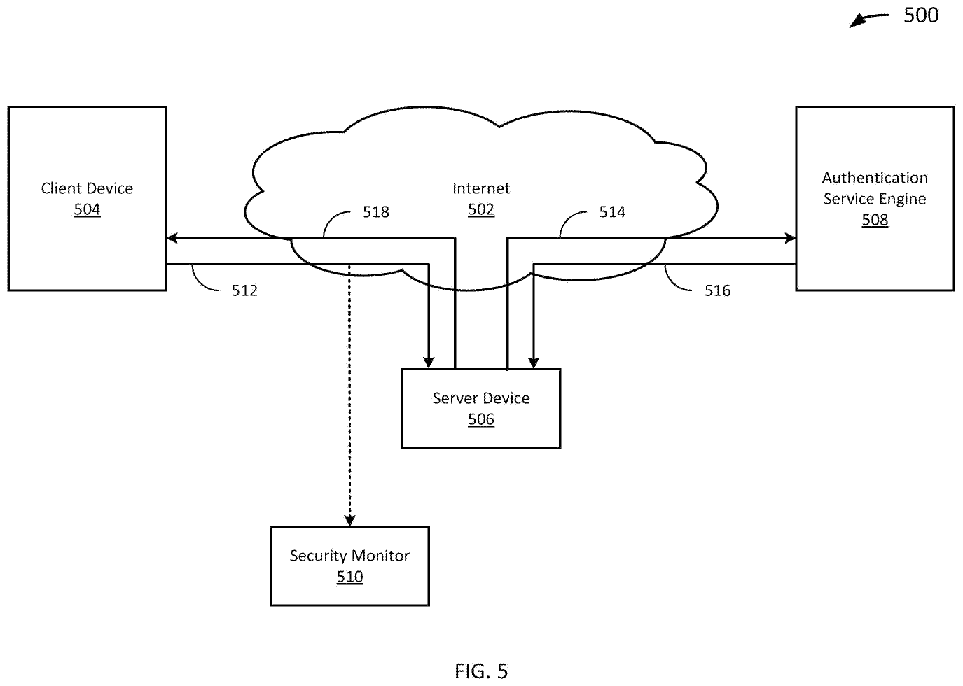

FIG. 5 is a logical diagram 500 of phases for new IPv6 destination address revocation through logout. The diagram 500 includes the Internet 502, a client device 504, a server device 506, an authentication service device 508, and a security monitor 510. The components 502-510 can be implemented in a manner like that described with reference to the components 302-310 of FIG. 3.

For the purposes of this example, an optional service includes additional security to logout of services. In a specific implementation, logout is initiated client-side to ensure authentication tokens are explicitly invalidated. In an alternative, enforcement of a server-side logout could be used, which would be like authentication token expiration as described above with reference to FIG. 4. It is assumed, for illustrative purposes, the server device 506 fulfilled a request from the client device 504 like the server device 306 of FIG. 3 fulfilled a request from the client device 304 of FIG. 3, as described previously, such that the client device 504 initially has an IPv6 destination address.

In transaction 512, the client device 504 sends a logout request to the server device 506 over the Internet 502. In a specific implementation, the logout request is sent to the server device 506, as indicated in the diagram 500, but in an alternative the logout request is sent directly to the authentication service engine 508. In either case, the client device 504 can be referred to as sending the logout request to the authentication service engine 508 (directly or indirectly, as the case may be). At this point, the client device 504 is in a pending logout state.

Continuing the example of Alice and Bob, Bob decides to end a session so he instructs his device to send a logout request to the authentication server via the web server. In a specific implementation, logout is optional, so Alice may decide not to logout (though her authentication token could expire, if applicable, as described above with reference to FIG. 4).

In transaction 514, in response to receiving the logout request, the server device 506 informs the authentication service engine 508 over the internet 502 of a logout event. At this point, the server device 506 is in a pending logout state with respect to the client device 504. As was mentioned previously, the client device 504 could send a logout request directly to the authentication service engine 508, bypassing the server device 506, essentially merging the transaction 512 and the transaction 514 into a “direct” transaction, and obviating the server device 506 explicitly entering a pending logout state with respect to the client device 504.

In transaction 516, in response to receiving the logout request, the authentication service engine 508 informs the server device 506 that the IPv6 destination address is revoked and updates client data, session data, or other records, if applicable. At this point, the authentication service engine 508 assumes logout is complete for the client device 504. Confirmation of a successful logout may or may not be received from the server device 506 (not shown) in the form of an ACK or some other form of feedback. The authentication service engine 508 may also produce an error if there is an issue with the logout request, such as if the logout request is for an expired address. The countermeasures or other action taken in response to an error will likely depend upon the threat the error signifies.

Continuing the example of Alice and Bob, the authentication server deactivates Bob's authentication token. In a specific implementation, Bob's authentication token is retired for a span of time.

In transaction 518, the server device 506 notifies the client device 504 over the Internet 502 the disposition of the logout request. Assuming the logout is successful, the server device 506 is in a logout successful state with respect to the client device 504 and, upon receipt of the logout success notification, the client device 504 enters a logout state, as well. The client device 504 may or may not provide feedback to the server device 506 that the logout success notification was received. If the logout is not successful, the server device 506 may or may not provide a notification of unsuccessful logout but in most instances, the applicable authentication token can still be deactivated, making most logout attempts at least partially successful absent a broken communication channel that prevents the logout request from being received.

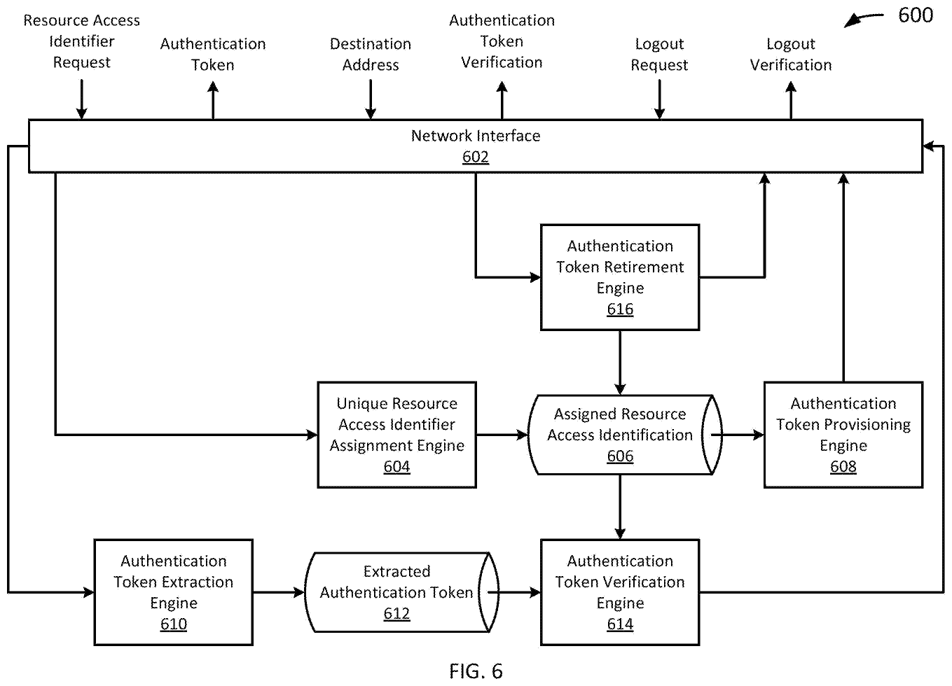

FIG. 6 is a diagram 600 of an example of a destination-based authentication system. The diagram 600 includes a network interface 602, a unique resource access identifier assignment engine 604 coupled to the network interface 602, an assigned resource access identification datastore 606 coupled to the unique resource access identifier assignment engine 604, an authentication token provisioning engine 608 coupled to the assigned resource access identification datastore 606 and the network interface 602. The diagram 600 also includes an authentication token extraction engine 610 coupled to the network interface 602, an extracted authentication token datastore 612 coupled to the authentication token extraction engine 610, and an authentication token verification engine 614 coupled to the assigned resource access identification engine 606 and the extracted authentication token datastore 612. The diagram 600 also includes an authentication token retirement engine 616 coupled to the network interface 602 and the assigned resource access identification engine 606.

The network interface 602 is intended to represent an interface suitable for receiving from a network a resource access identifier request and sending an authentication token in response and for receiving a destination address and sending an authentication token verification in response. Although depicted as a network interface, it should be understood a network interface could be replaced with some other applicable means for obtaining and providing the requisite data, such as a database interface, a bus, a buffer, or the like.

The unique resource access identifier assignment engine 604 is intended to represent an engine that, in response to a resource access identifier request, assigns a globally unique identifier to an entity for use in requesting resource access. Because the identifier is globally unique, the identification can be incorporated into a standard protocol packet header of a size sufficient to encompass the identification (e.g., authentication token).

The assigned resource access identification datastore 606 is intended to represent a datastore of assigned authentication tokens. In a specific implementation, authentication tokens can expire after a span of time or after a session expires, be retired when a logout process is initiated, or purged in some other manner. For this reason, a globally unique assignment of an authentication token should not be considered a permanent assignment and a first entity can be assigned a first authentication token at a first time, then be assigned a second authentication token after the first authentication token expires or is retired or otherwise purged.

The authentication token provisioning engine 608 is intended to represent an engine that responds to the resource access identifier request with the assigned authentication token. Although the diagram 600 is intended to show the authentication token being provisioned via the network interface 602, some other technique for provisioning the authentication token can be used and the resource access identifier request and response with an authentication token can be accomplished via different channels, depending upon implementation-, configuration-, or preference-specific factors.

It may be noted a reauthentication process can be accomplished in a manner similar to that described above with reference to components 602-608. In a specific implementation, an assigned authentication token is not re-validated; rather, a new authentication token is assigned in response to a reauthentication request. Data maintained from a first authentication request may be retained after a reauthentication request (e.g., in association with a source address in the header of multiple resource access identifier requests). If a destination address is size-constrained, there may be more incentive to reauthenticate with an old authentication token but such a process is likely unnecessary with IPv6-compatible implementations due to the size of the IPv6 address.

The authentication token extraction engine 610 is intended to represent an engine that extracts an authentication token from a destination address received via the network interface 602. The extracted authentication token is stored in the extracted authentication token datastore 612. In a specific implementation, the destination address is an IPv6 address of a resource server that has the authentication token incorporated therein.

The authentication token verification engine 614 is intended to represent an engine that compares the extracted authentication token of the extracted authentication token datastore 612 with authentication tokens stored in the assigned resource access identification datastore 606. In a specific implementation, the extracted authentication token is only compared with active (e.g., not expired or retired) assigned authentication tokens to determine whether the extracted authentication token is valid. Instead or in addition, the authentication verification engine 614 compares the extracted authentication token with active and inactive authentication tokens. In this way, the system can gain some insight into why an authentication token is invalid (e.g., it could be invalid because it expired after a session expired, it could be invalid because of a logout, etc.). Although the diagram 600 is intended to show the authentication token verification being provisioned via the network interface 602, some other technique for provisioning the authentication token verification can be used and the destination address and response with an authentication token verification can be accomplished via different channels, depending upon implementation-, configuration-, or preference-specific factors.

The authentication token retirement engine 616 is intended to represent an engine that, responsive to a logout request received on the network interface 602, updates the assigned resource access identification datastore 606 to indicate an authentication token for the client on behalf of which the logout request is being sent is no longer active, and provides a logout verification on the network interface 602 after the update is completed. The authentication token retirement engine 616 is optional but it is likely desirable from a security perspective to ensure authentication tokens are retired after a session, after a span of time, or after a logout request is received.

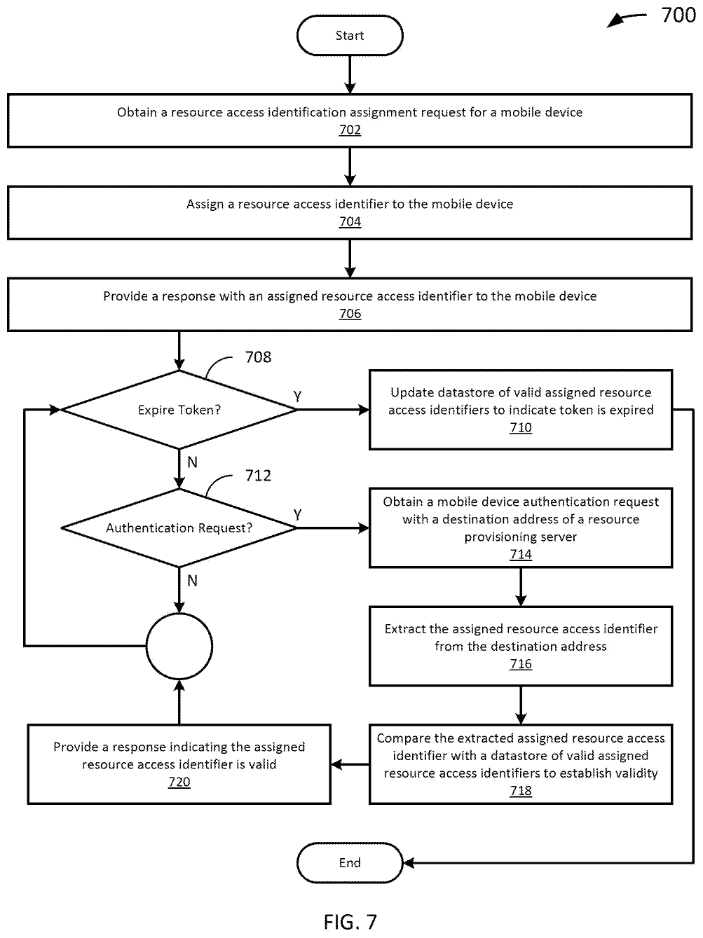

FIG. 7 is a flowchart 700 of an example of a method of destination-based policy selection and authentication. The flowchart 700 and other flowcharts described in this paper can be reordered or reorganized for parallel execution of modules, if applicable.

The flowchart 700 starts at module 702 with obtaining a resource access identification assignment request for a mobile device. The resource access identification assignment request can be characterized as an authentication request. The resource access identification assignment request can be received via a network interface, read from a database via a database interface, or received from the mobile device, directly or indirectly, in some other applicable manner. Instead or in addition, the resource access assignment request can come from a device other than a mobile device. An engine suitable for obtaining a resource access identification assignment request is an authentication services engine, such as the authentication services engine 116 of FIG. 1, the authentication service engine 308 of FIG. 3, or the network interface 602 of FIG. 6.

The flowchart 700 continues to module 704 with assigning a resource access identifier to the mobile device. The assigned resource access identifier can be characterized as an access token. Instead or in addition, the resource access identifier can be assigned to a device other than a mobile device. An engine suitable for assigning a resource access identifier is an authentication services engine, such as the authentication services engine 116 of FIG. 1, the authentication service engine 308 of FIG. 3, or the unique resource access identifier assignment engine 604 of FIG. 6.

The flowchart 700 continues to module 706 with providing a response with an assigned resource access identifier to the mobile device. Like as was indicated above, the response providing the assigned resource access identifier can be characterized as a response to an authentication request and the assigned resource access identifier can be characterized as an access token. In a specific implementation, the access token can be incorporated into an IPv6 destination address, which can be used by the mobile device when attempting to access resources from a server that corresponds to the IPv6 destination address. The assigned resource access identifier can be sent via a network interface, written to a database via a database interface, or provided to the device, directly or indirectly, in some other applicable manner. Instead or in addition, the assigned resource access identifier can be provided to a device other than a mobile device. An engine suitable for providing a response with an assigned resource access identifier is an authentication services engine, such as the authentication services engine 116 of FIG. 1, the authentication service engine 308 of FIG. 3, or the authentication token provisioning engine 608 of FIG. 6.

The flowchart 700 continues to decision point 708 where it is determined whether to expire a token. Token expiration can occur after a span of time, after a session ends, after a logout request is received, or in accordance with some other methodology. If it is determined to expire a token (708-Y), then the flowchart 700 ends at module 710 with updating a datastore of valid assigned resource access identifiers to indicate a token is expired. Although the flowchart 700 ends with the expiration of the token, it should be understood tokens can be reauthenticated, a new token can be authenticated, and there may be other tokens that are not expired in the datastore of valid assigned resource access identifiers after it is updated to expire a single token. An engine suitable for providing a response with an assigned resource access identifier is an authentication services engine, such as the authentication services engine 116 of FIG. 1, the authentication service engine 508 of FIG. 5, or the authentication token retirement engine 616 of FIG. 6.

If, on the other hand, it is determined not to expire a token (708-N), then the flowchart 700 continues to decision point 712 where it is determined whether there is an authentication request. If it is determined there is no authentication request (712-N) then the flowchart 700 returns to decision point 708 and continues as described previously, until either the token expires or there is an authentication request.

If, on the other hand, it is determined there is an authentication request (708-Y), then the flowchart 700 continues to module 714 with obtaining a mobile device authentication request with a destination address of a resource provisioning server. The mobile device authentication request can be received via a network interface, read from a database via a database interface, or received from the resource provisioning device, directly or indirectly, in some other applicable manner. Instead or in addition, the device authentication request can be other than a mobile device authentication request. An engine suitable for obtaining a mobile device authentication request with a destination address of a resource provisioning server is an authentication services engine, such as the authentication services engine 116 of FIG. 1, the authentication service engine 308 of FIG. 3, or the network interface 602 of FIG. 6.

The flowchart 700 continues to module 716 with extracting the assigned resource access identifier from the destination address. Like as was indicated above, the assigned resource access identifier can be characterized as an access token. An engine suitable for extracting the assigned resource access identifier from the destination address is an authentication services engine, such as the authentication services engine 116 of FIG. 1, the authentication service engine 308 of FIG. 3, or the authentication token extraction engine 610 of FIG. 6.

The flowchart 700 continues to module 718 with comparing the extracted assigned resource access identifier with a datastore of valid assigned resource access identifiers to establish validity. Like as was indicated above, the assigned resource access identifier can be characterized as an access token. An engine suitable for comparing the extracted assigned resource access identifier with a datastore of valid assigned resource access identifiers to establish validity is an authentication services engine, such as the authentication services engine 116 of FIG. 1, the authentication service engine 308 of FIG. 3, or the authentication token verification engine 614 of FIG. 6.

The flowchart 700 continues to module 720 with providing a response indicating the assigned resource access identifier is valid. Like as was indicated above, the assigned resource access identifier can be characterized as an access token. The validity of the assigned resource access identifier can be sent via a network interface, written to a database via a database interface, or provided to the resource provisioning server, directly or indirectly, in some other applicable manner. An engine suitable for providing a response indicating the assigned resource access identifier is valid is an authentication services engine, such as the authentication services engine 116 of FIG. 1, the authentication service engine 308 of FIG. 3, or the network interface 602 of FIG. 6.

The flowchart 700 then returns to decision point 708 and continues as described previously, until either the token expires or there is an authentication request.

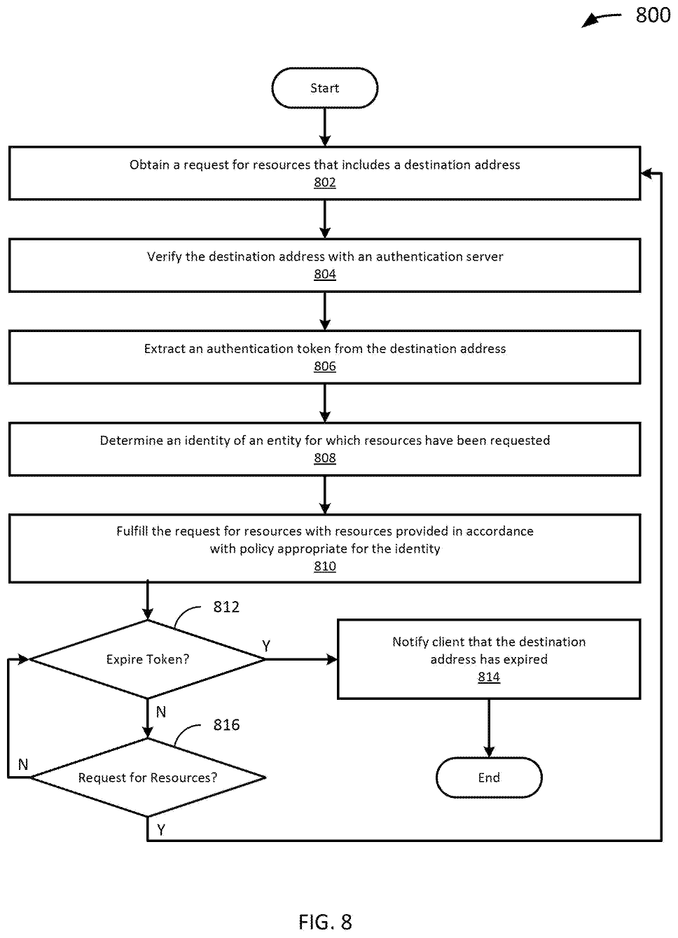

FIG. 8 is a flowchart 800 of an example of a method for providing resources in accordance with destination-based policy selection and authentication. The flowchart 800 starts at module 802 with obtaining a request for resources that includes a destination address. In a specific implementation, the destination address is an IPv6 destination address provided in the header of an IP packet from a mobile device. The request for resources can be received via a network interface, read from a database via a database interface, or received from the mobile device, directly or indirectly, in some other applicable manner. Instead or in addition, the request for resources can come from a device other than a mobile device. An engine suitable for obtaining a request for resources is a identity-based policy enforcement and service provisioning system, such as the identity-based policy enforcement and service provisioning system (or engine) 118 of FIG. 1, the server device 306 of FIG. 3, or a network interface of the identity-based policy enforcement and service provisioning engine 118 (not shown) or the server device 306 (not shown). A datastore suitable for storing the destination address is a client-specific address datastore, such as the client-specific address datastore 120 of FIG. 1.

The flowchart 800 continues to module 804 with verifying the destination address with an authentication server. In a specific implementation, the destination address is provided in its entirety to the authentication server where the network (potentially including subnet) address portion of the destination address is considered in combination with the authentication token portion for the purpose of authentication. In an alternative, the authentication token is provided without the network address portion of the destination address. Where the authentication token is considered alone, without using the network address portion of the destination address, assignment of authentication tokens can be more complex, but if the complexity is acceptable, extraction of the authentication token from the destination address (module 806) can be done prior to verifying with the authentication server and the authentication token portion of the destination address, without the network address portion, can be provided to the authentication server. That said, a packet from the server that provides resources in accordance with destination-based policy selection and authentication and received at the authentication server will also have a source address, which can be considered instead of or in addition to the network address portion of the destination address that is being authenticated in association with the authentication token. An engine suitable for verifying the destination address with an authentication server is a identity-based policy enforcement and service provisioning system, such as the identity-based policy enforcement and service provisioning system (or engine) 118 of FIG. 1, the server device 306 of FIG. 3, or a network interface of the identity-based policy enforcement and service provisioning engine 118 (not shown) or the server device 306 (not shown). A datastore suitable for storing the destination address is a client-specific address datastore, such as the client-specific address datastore 120 of FIG. 1.

The flowchart 800 continues to module 806 with extracting an authentication token from the destination address. In a specific implementation, the authentication token is extracted from the destination address at a server that provides resources in accordance with destination-based policy selection and authentication. Instead or in addition, the authentication token can be extracted at an authentication server. An engine suitable for extracting an authentication token from the destination address is a identity-based policy enforcement and service provisioning system, such as the identity-based policy enforcement and service provisioning system (or engine) 118 of FIG. 1, the server device 306 of FIG. 3, or a network interface of the identity-based policy enforcement and service provisioning engine 118 (not shown) or the server device 306 (not shown). A datastore suitable for storing the destination address is a client-specific address datastore, such as the client-specific address datastore 120 of FIG. 1.

The flowchart 800 continues to module 808 with determining an identity of an entity for which resources have been requested. In a specific implementation, the authentication token identifies a client to which resources are served. Instead or in addition, an authentication server can provide unique information associated with the client in a form that is different than the authentication token, such as a client source address that can be matched to the source address of the request for resources. The authentication server will also provide validity information, though the validity information may be implicit from a response that includes the authentication token (as opposed to a response that omits the authentication token) or the lack of the authentication token if the protocol is such that the response only returns the authentication token if it is invalid. Validity information can also be explicit, associated with a session, associated with a time-to-live timestamp, or come in some other format understandable to the server that provides resources in accordance with destination-based policy selection and authentication. An engine suitable for determining an identity of an entity for which resources have been requested is a identity-based policy enforcement and service provisioning system, such as the identity-based policy enforcement and service provisioning system (or engine) 118 of FIG. 1, the server device 306 of FIG. 3, or a network interface of the identity-based policy enforcement and service provisioning engine 118 (not shown) or the server device 306 (not shown). A datastore suitable for storing the destination address is a client-specific address datastore, such as the client-specific address datastore 120 of FIG. 1.

The flowchart 800 continues to module 810 with fulfilling the request for resources with resources provided in accordance with policy appropriate for the identity. In a specific implementation, based upon identity, a first client will receive first resources and a second client will receive second resources. Similarly, in this specific implementation, based upon identity, a first policy will be enforced for the first client and a second policy will be enforced for the second client. An engine suitable for fulfilling the request for resources with resources provided in accordance with policy appropriate for the identity is a identity-based policy enforcement and service provisioning system, such as the identity-based policy enforcement and service provisioning system (or engine) 118 of FIG. 1, the server device 306 of FIG. 3, or a network interface of the identity-based policy enforcement and service provisioning engine 118 (not shown) or the server device 306 (not shown). A datastore suitable for storing the destination address is a client-specific address datastore, such as the client-specific address datastore 120 of FIG. 1. An engine suitable for enforcing policy from a policy datastore is the identity-based policy enforcement engine 122 (and the policy datastore 124) of FIG. 1. An engine suitable for providing resources from a resources datastore is the identity-based resource provisioning engine 126 (and the resources datastore 128) of FIG. 1.

The flowchart 800 continues to decision point 812 with determining whether a token is to expire. If it is determined a token is to expire (812-Y), then the flowchart 800 ends at module 814 with notifying a client that the destination address has expired. The expiration of the token can be initiated by a client through, for example, a logout request, or by a server through, for example, reaching the end of a time-to-live timer for the authentication token. If, on the other hand, it is determined a token is not to expire (812-N), then the flowchart continues to decision point 816 where it is determined whether there is a request for resources. If it is determined there is a request for resources (816-Y), then the flowchart 800 returns to module 802 and continues as described previously. If, on the other hand, it is determined there is no request for resources (816-N), then the flowchart 800 returns to decision point 812 and loops until either the token expires or there is a request for resources. Depending upon implementation-, configuration-, or preference-specific factors, an authentication token may or may not expire mid-session; if the authentication token does not expire mid-session, there may be no intervening authentication and/or identity determinations between packets associated with a single session.

1. A method comprising:
receiving a resource request at a server associated with an IPv6 destination address included in the resource request;
validating an authentication token that is incorporated into the IPv6 destination address;
using at least the authentication token to determine policy for the resource request;
using at least the IPv6 destination address to provide an individualized response in accordance with the policy for the resource request.

2. The method of claim 1, comprising:
receiving authentication information at an authentication server from a client, wherein the client is identifiable, at least in part, from a source address;
using the source address for impersonation attack prevention.

3. The method of claim 1, wherein a client sends authentication information to an authentication server to obtain the IPv6 destination address with the authentication token incorporated therein.

4. The method of claim 1, wherein the authentication token is pseudo-randomly generated at an authentication server.

5. The method of claim 1, wherein the authentication token takes up no more than the last 64 bits of the IPv6 address.

6. The method of claim 1, comprising extracting the authentication token from the IPv6 destination address.

7. The method of claim 1, wherein the authentication token is validated by matching the authentication token to a list of assigned authentication tokens at an authentication server.

8. The method of claim 1, comprising monitoring for suspicious attempts to request services, wherein suspicious attempts to request service are selected from a group consisting of repeated requests to invalid destination addresses, requests to expired destination addresses, requests to destination addresses from another network not otherwise identified with an existing authentication token, and a combination of these.

9. A method comprising:
issuing a second authentication token in association with a device;
embedding a network address and the second authentication token in an IPv6 address;
receiving a request for services using the IPv6 address as a destination address;
verifying the second authentication token of the IPv6 address;
providing requested services using identity-based policy enforcement when the second authentication token is determined to be valid, wherein the identity of the device is established using at least the second authentication token.

10. The method of claim 9, comprising:
notifying the device that the network address and a first authentication token are expired;
receiving a request for reauthentication based on identifying information sufficient to establish the identity of the device and valid continuance of a need to request service;
expiring the first authentication token.

11. The method of claim 10, wherein authentication tokens, including the first authentication token and the second authentication token, are expired at routine intervals.

12. The method of claim 10, wherein a subnetwork address is expired when the network address and the first authentication token are expired, comprising embedding the subnetwork address along with the network address and the second authentication token in the IPv6 address.

13. The method of claim 9, comprising:
receiving a logout request;
invalidating an existing session such that the destination address and the second authentication token are no longer valid for requesting service.

14. The method of claim 9, comprising monitoring for suspicious attempts to request services, wherein suspicious attempts to request service are selected from a group consisting of repeated requests to invalid destination addresses, requests to expired destination addresses, requests to destination addresses from another network not otherwise identified with an existing authentication token, and a combination of these.

15. A system comprising:
a client requesting service from a server that is aware it needs to send authenticating information to an authentication server directly or via the server from which the client is requesting service;
the authentication server, which is configured to validate authentication information and generate a destination address that includes a network address and an authentication token;
the server from which the client is requesting service, wherein the server is configured to parse out the authentication token from the destination address and validate the authentication token with the authentication server.

16. The system of claim 15, wherein suspicious attempts to request service are selected from a group consisting of repeated requests to invalid destination addresses, requests to expired destination addresses, requests to destination addresses from another network not otherwise identified with an existing authentication token, and a combination of these.

17. The system of claim 15, wherein the destination address is an IPv6 address.

18. The system of claim 15, wherein the authentication server validates authentication information and includes source network and other information in generating the destination address to prevent impersonation attacks.

19. The system of claim 15, wherein the destination address that the authentication server generates includes a subnetwork address, as well as the network address and the authentication token.

20. The system of claim 15, comprising a security monitor that monitors for suspicious attempts to request services.
